(19) United States
(12) Patent Application Publication
(10) Pub. No.: US 2026/0325259 A1
(43) Pub. Date: Oct. 22, 2026

(54) ADJUSTABLE ANTERIOR DEPROGRAMMER DENTAL SPLINT

(71) Applicant: Erik Mendelsohn, Egg Harbor Twp, NJ (US)

(72) Inventor: Erik Mendelsohn, Egg Harbor Twp, NJ (US)

(21) Appl. No.: 19/183,899

(22) Filed: Apr. 20, 2025

(51) Int. Cl. A61C 7/08; A61C 7/36

(52) U.S. Cl. CPC A61C 7/08; A61C 7/36

(57) ABSTRACT

An adjustable anterior deprogrammer dental splint features a U-shaped tray 104 with a smooth floor 148 and a central gap 132 spanning portions of at least four incisors. The gap 132 permits about 3 mm anterior-posterior adjustment (offset 194) and tilting without lip impingement. A ramp 108, with thickness Ti tapering linearly from about 6 mm at the anterior end 160 (T1) to a thinner posterior end (T2), spans a portion of at least three incisors (WC) to separate jaws and reduce clenching. The tray's back end 168 pivots at a premolar or molar (fulcrum 168), adjusting vertical dimension occlusion (VDO) with affixing material thickness 172. Chamfered ramp sides (angle α) and a complementary angle α′ (25-45°) guide side-to-side jaw motion, resisting incisor interference. A rear space 196 (about 0.001 inches) minimizes muscle recruitment, enhancing fit and comfort.

### BACKGROUND OF THE INVENTION

### Field of the Invention

This patent application relates to dental splints used to reduce the harmful effects of unconscious teeth clenching in mammals, particularly humans. It focuses on anterior deprogrammers—devices that keep upper and lower back teeth apart to lessen muscle strain.

### Related Art

Anterior deprogrammers are dental splints or guards that include elements to keep top and bottom-posterior teeth from touching. Existing designs include German patent No. DE102013110427, which discloses a tray with a socket for upper teeth and a projection contacting lower incisors, featuring an uninterrupted front wall across the frenal area.

U.S. Pat. No. 10,500,083 (Boyd) discloses a splint for upper or lower incisors with a tray and a projection to separate posterior teeth, echoed in U.S. Pat. No. 6,666,621 (Boyd).

U.S. Pat. No. 7,556,044 (Ball) presents a splint with a short tray spanning top incisors to canines, including a conforming socket and a spacer for jaw separation.

These examples highlight ongoing efforts to address clenching through varied splint configurations tailored to patient needs, but may lack adjustability and comfort when worn by a patient overnight.

### SUMMARY

This application discloses an adjustable-anterior-deprogrammer-dental splint that separates posterior teeth to reduce jaw clenching, providing enhanced fit and comfort compared to conventional designs through adjustable positioning. It features a U-shaped tray that fits in the mouth, typically on the upper jaw (adaptable to the lower jaw), with a smooth floor and a central gap in its exterior wall. This gap enables forward and backward sliding—up to about 3 mm—to suit different jaw sizes. A ramp beneath the tray, thicker at the front and tapering rearward, wedges the jaws apart. The tray's back end pivots as a fulcrum, allowing tilting during installation to fine-tune jaw separation. These adjustments—sliding and tilting—enhance adaptability and prevent lip impingement, while chamfered ramp sides guide side-to-side jaw movement smoothly. The splint is described in greater detail below with reference to the Detailed Description and figures.

### BRIEF DESCRIPTION OF THE DRAWINGS

The drawings illustrate the splint's structure and use, with numbered elements:

FIG. 1 is a perspective view from above of splint 100, showing tray 104, ramp 108, socket 112, interior wall 116, exterior wall 120 with central gap 132, and retention features 152.

FIG. 2 is a perspective view from below of splint 100, showing ramp 108 with anterior end 160, posterior end, and bottom surface 176 attached to tray bottom 174.

FIG. 3 is a top view of splint 100, showing tray 104 with centerline 106, socket 112, floor 148, interior wall 116 (right portion 136, central portion 140, left portion 144), exterior wall 120 (right portion 124, left portion 128, central gap 132), and imaginary arc 180.

FIG. 4 is a front view of splint 100, showing tray 104 with exterior wall 120 (right portion 124, left portion 128, central gap 132 with depth DG to floor top surface 164), and ramp 108 with chamfer angle α.

FIG. 5 is a rear view of splint 100, showing tray 104 with interior wall 116 (right portion 136, central portion 140, left portion 144) and ramp 108.

FIG. 6 is a bottom view of splint 100, showing tray bottom 174 and ramp 108 with anterior end 160 (thickness T1), posterior end (thickness T2), and width WC.

FIG. 7 is a right-side view of splint 100, showing tray 104 with back end 168 and ramp 108 from anterior end 160 to posterior end.

FIG. 8 is a left-side view of splint 100, showing tray 104 with back end 168 and ramp 108 from anterior end 160 to posterior end.

FIG. 9 is a front view of splint 100 installed between upper jaw 184 and lower jaw 188, showing ramp bottom surface 176 contacting three incisors, incisor 192, and complementary angle α′.

FIG. 10 is a right-side view of splint 100 installed between upper jaw 184 and lower jaw 188, showing tray 104 with back end 168, ramp 108, and rear space 196.

FIG. 11 is a right-side view of splint 100 from FIG. 10, with tray 104 slid forward (offset 194), showing ramp 108 and rear space 196.

FIG. 12 is a right-side view of splint 100 from FIG. 10, with tray 104 tilted at angle ø around fulcrum 168, showing ramp 108, affixing material thickness 172, and rear space 196.

### DETAILED DESCRIPTION

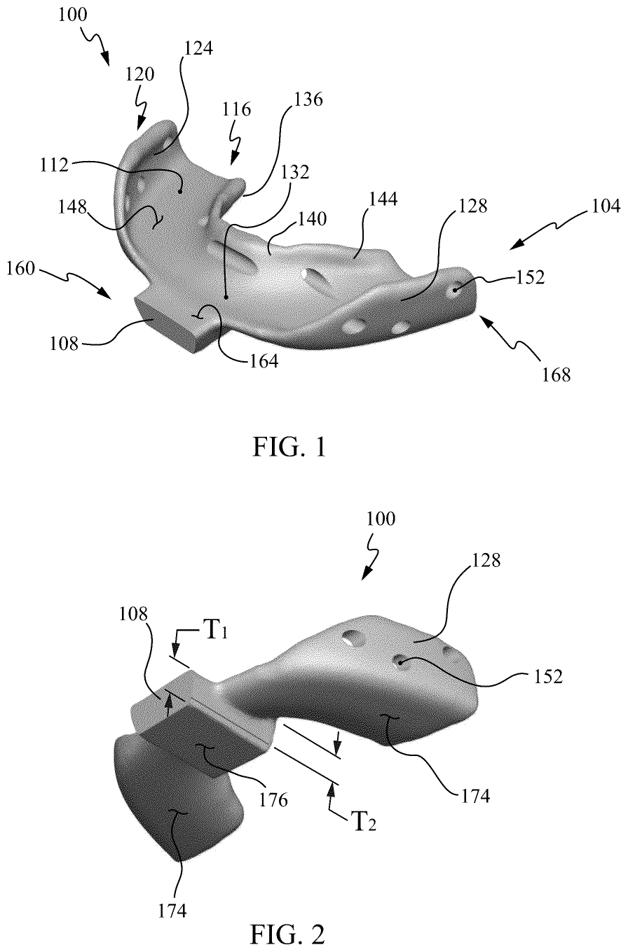

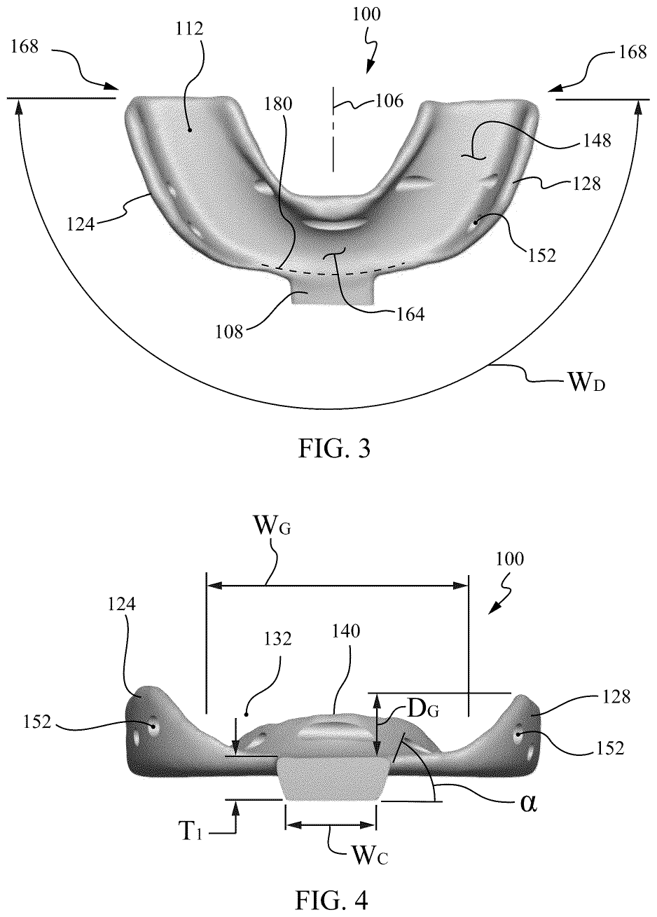

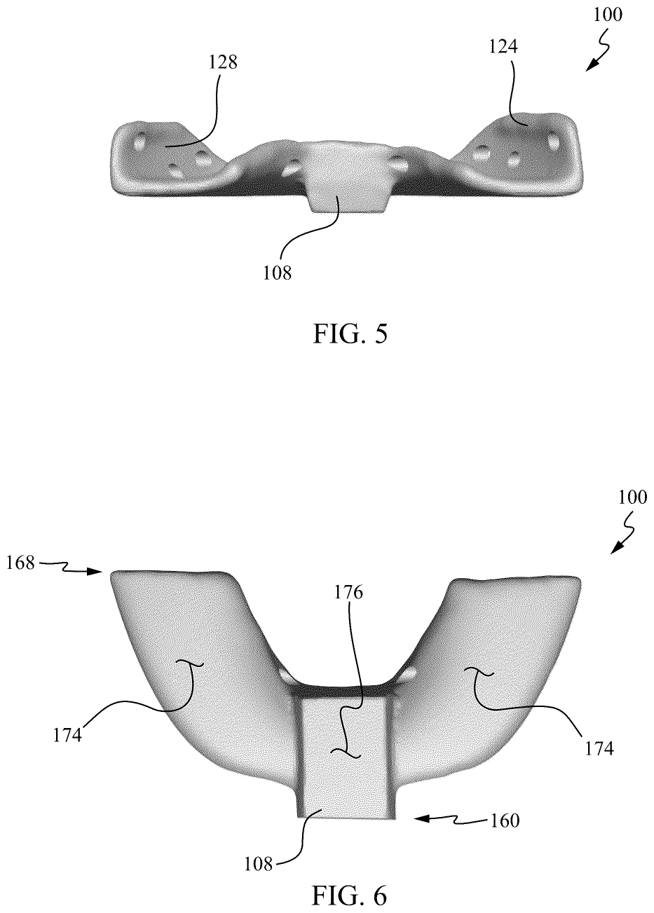

The adjustable anterior deprogrammer dental splint, shown as splint 100 in FIGS. 1-8, comprises a U-shaped tray 104 and a ramp 108. The tray 104 is configured to fit inside a mammal's mouth, typically a human's upper jaw 184 (adaptable to lower jaw 188), and is symmetrical along centerline 106 (FIG. 3). It holds teeth in a socket 112, formed between an interior wall 116 (with right portion 136, central portion 140, and left portion 144; FIGS. 3, 5) and an exterior wall 120 (with right portion 124 and left portion 128, separated by central gap 132; FIGS. 1, 3, 4).

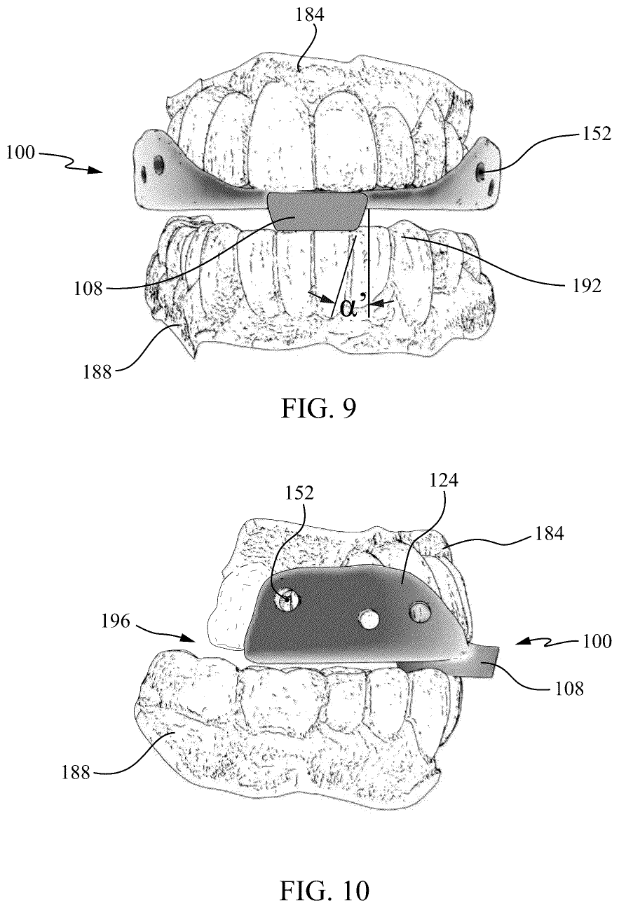

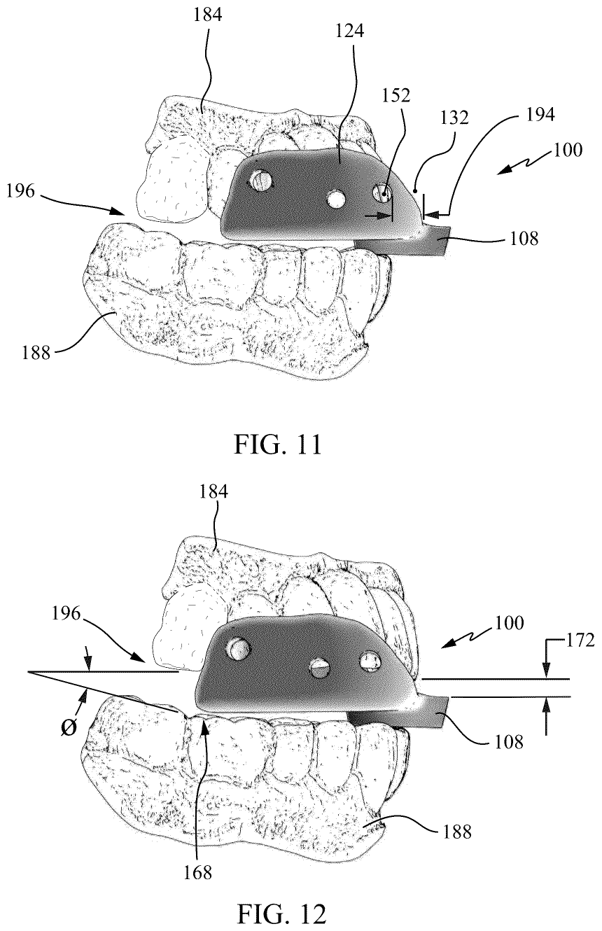

The socket 112 features a smooth floor 148 (FIG. 3), enabling teeth to slide for anterior-posterior adjustment. The central gap 132, with a width WG spanning at least four incisors (FIG. 9) and a depth DG reaching the floor's top surface 164 (FIG. 4), permits the tray 104 to move up to about 3 mm (offset 194, FIGS. 10-11) between maximum anterior and posterior installation positions. This adjustment aligns an incisor with an imaginary arc 180 between wall portions 124 and 128 (FIG. 3), enhancing fit flexibility. Apertures 152, indents, protrusions, or other retention features in tray 104 (FIG. 1) secure affixing material, such as dental adhesive or moldable compound, to resist escape and ensure temporary installation.

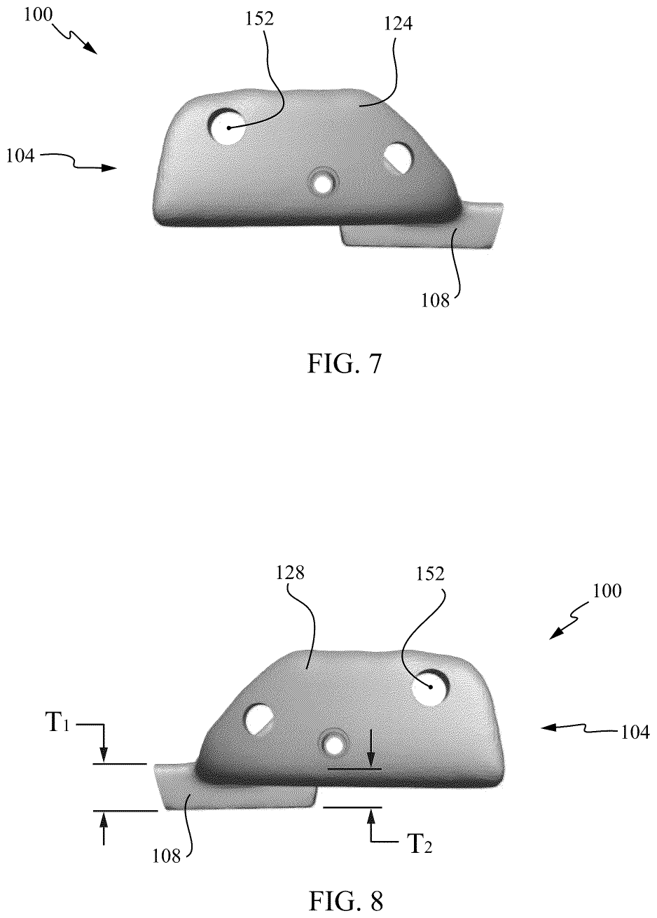

The ramp 108, affixed to the tray's bottom 174 (FIGS. 2, 6), extends from an anterior end 160 to a posterior end (FIGS. 7, 8). The anterior end 160 is cantilevered from the tray's front (FIGS. 1, 2), providing an extended bottom surface 176 (FIGS. 2, 9) for lower incisors during grinding. The posterior end may also cantilever from the tray's back (FIGS. 7, 8). The ramp 108 provides a thickness Ti that tapers linearly from a maximum of about 6 mm at the anterior end 160 (T1) to a minimum thickness T2 at the posterior end (FIG. 6), acting as a wedge to separate jaws (FIG. 10). Sliding the tray 104 adjusts this separation (FIG. 11). The ramp's width WC spans a portion of at least three incisors (FIGS. 6, 9), and its transverse sides are chamfered at 45 to 65 degrees from horizontal (angle α, FIG. 4). This chamfer guides the jaw open if the ramp 108 contacts a canine tooth during side-to-side jaw excursions, with a complementary angle α′ of about 25 to 45 degrees from vertical (FIG. 9) to resist crash-like interference between ramp 108 and an incisor 192.

The tray 104 extends laterally in a wrap direction WD (FIG. 3) to at least the posterior end of a premolar on each side, optionally to a molar's middle (FIGS. 7, 8). Its back end 168, aligned vertically with a premolar or molar, serves as a fulcrum 168 (FIGS. 7, 8, 10). Tilting the tray 104 around this fulcrum at angle ø during installation (FIG. 12) adjusts the vertical dimension occlusion (VDO), adding space between the top incisor and ramp top surface 164 via affixing material thickness 172 (FIG. 12). The central gap 132 prevents lip impingement during tilting (FIGS. 4, 12).

For installation, the ramp's front third (surface 176) aligns with lower incisors (FIGS. 10-11), ensuring they stay on the ramp 108 during jaw motion. The tray 104 typically stops near the first molar or the tooth before it (FIGS. 7, 8, 10), avoiding full molar coverage for comfort. This maintains a minimum rear space 196 between top and bottom posterior molars (FIGS. 10-12), illustrated in an exaggerated condition for visibility. A smaller separation 196, on the order of about 0.001 inches or so, is sufficient to reduce jaw-clenching muscle recruitment.

Ramp 108 provides a thickness Tᵢ for disposal as a wedge between top and bottom incisors. Thickness Tᵢ causes a vertical dimension occlusion (VDO) to maintain jaws in a separated configuration. The ramp thickness varies from a maximum thickness T₁ at the anterior ramp end, generally indicated at 160, toward a minimum thickness T₂ at the posterior ramp end. In an embodiment, the ramp thickness Tᵢ varies as a linear function of distance from one end of the ramp 108. Consequently, a separation distance between top and bottom incisors may be adjusted by sliding the tray 104 in an anterior or posterior direction during installation of the tray 104.

A further increase in spacing between top and bottom incisors may be effected by using structure associated with a posterior end 168 of the tray 104 as a fulcrum during installation of splint 100 with affixing material. The affixing material may conveniently be formed as a secondary wedge having a thickness disposed between top incisors and the top surface 164 of the ramp 104. A fulcrum at the posterior end 168 of tray 104 may be effected with a top molar or premolar. An additional wedge thickness 172, which may be provided by arranging affixing material to cause tray rotation at angle ø during tray installation, is shown in FIG. 12.

Ramp 108 may be characterized as a generally prismatic element that is affixed to the tray 104. In one embodiment, ramp 108 projects in a thickness direction from the bottom surface 174 of the tray 104. As shown, ramp 108 extends in a length axis direction posteriorly from anterior ramp end 160 toward a posterior ramp end. It is currently an option for the anterior ramp end 160 to be disposed as a cantilevered element from the anterior end of the tray 104. That configuration provides an extended length of ramp bottom surface 176. Consequently, bottom incisors remain in contact with surface 176 during front-to-rear grinding motion of the jaws. The posterior end of ramp 108 may similarly project as a cantilevered element from an opposite side of the tray 104 from the anterior ramp end 160.

In one implementation, ramp 108 is configured to resist crashing into left and right incisors during side-to-side jaw excursions. As shown in FIG. 4, bottom corners of ramp 108 may be angled or chamfered by an angle α to make an inclined plane that can slide with respect to an incisor edge. Oppositely disposed transverse sides of the ramp 108 include a chamfer that is angled to urge mouth opening in the event of a ramp edge contact with a canine tooth. Consequently, interaction between ramp 108 and an incisor induces motion in a jaw-opening direction, instead of causing an abrupt stop-inducing interference. A workable chamfer angle α is between about 45 degrees and about 65 degrees from horizontal. It is an option for a ramp 108 to provide a contact surface 176 having a width W_{C} for contact with a portion of at least three incisors (see FIG. 9). Nonetheless, as appreciated by those skilled in the art, after having the benefit of this disclosure, that the contact portion may include more or fewer than three incisors.

With reference to FIGS. 3 and 4, exterior wall 120 has a generally uniform depth. Gap 132 may have a maximum full depth D_{G} to expose the floor top surface 164 in the vicinity of the incisors. Gap 132 may also have a nominal gap width W_{G} that encompasses portions of at least the four incisors of the jaw on which it is to be installed (e.g., see FIG. 9). This configuration enhances anterior-posterior adjustment of the tray 104 during its installation. Consequently, a top incisor may be located at a maximum anterior position to land on surface 164 and occupy space of an imaginary front wall portion (e.g., represented by dashed line 180 in FIG. 3) extending as an arc in the gap 132 between the left wall portion 128 and the right wall portion 124 of exterior wall 120. Gap 132 also inherently removes rim material of socket 112 that otherwise might impinge on the inner surface of a patient's lip (e.g., if the tray 104 is rotated to increase vertical dimension occlusion).

FIGS. 9-12 illustrate an example splint 100 variably installed between an upper jaw 184 and a lower jaw 188. Note that the illustrated jaws reflect a non-typical real-world example, and are not symmetrical. FIG. 9 illustrates potential contact of ramp bottom surface 176 with a portion of at least three incisors. Also, a complementary angle α′ is pointed out to resist a crash-like interference between ramp 108 and an incisor 192 during side-to-side jaw excursions. A workable complementary angle α′ is between about 25 degrees and 45 degrees from vertical. An offset distance 194 between maximum anterior and posterior installation positions of tray 104 is illustrated between FIG. 10 and FIG. 11. Example splints 100 permit distance 194 to encompass up to about 3 mm, or so. FIGS. 10-12 illustrate a minimum rear space, generally indicated at 196, between top and bottom posterior molars that is caused by presence of splint 100. The rear space 196 is illustrated in an exaggerated condition for visibility. It is recognized that a smaller separation 196 (on the order of 0.001, or so) is sufficient to reduce jaw-clenching muscle recruitment.

During installation, the position of the ramp is typically determined by the position of the lower incisor teeth. Splint 100 may be positioned anteriorly or posteriorly so that the lower incisor teeth hit in the front ⅓ of the ramp 108. This ensures that if a person slides forward or backward, their teeth don't go past either proximal or anterior ends of the ramp 108.

In one example, an installed tray 104 does not wrap or fully engage the molars. The posterior end 168 is typically configured to stop approximately at the first molar or the tooth in front. If the molars are fully involved, the mouth has to be open more in order to prevent the top and bottom back teeth from contacting the tray 104. Patients generally find it to be more comfortable for their mouth to be as fully closed as possible.

Gap 132 provides some advantages over other known anterior deprogrammers. First, an anterior-deprogrammer splint 100 can be rotated to alter the VDO since the front of the rim is cut away, allowing more freedom in placement of the device. If the tray is not cut away, and rotated, the front of the tray would otherwise protrude into the lip. Second, if the central portion of wall 120 in a tray 104 is not cut out in the front to form gap 132, you also can't slide the tray 104 posteriorly, since the front teeth will hit a central portion of exterior wall 120 of the tray 104. As shown between FIG. 11 and FIG. 12, sliding splint 100 in a posterior direction inherently increases the separation between the molars due to the increased ramp thickness that is consequently disposed between incisors.

While one embodiment is described, variations in elements such as gap size or ramp configuration are contemplated within the scope of the claims.

1. An adjustable anterior deprogrammer dental splint, comprising: a substantially U-shaped tray configured to fit into a mouth of a mammal, the tray having a tooth-receiving socket with a floor spacing apart an interior wall and an exterior wall, the exterior wall including a left wall portion, a right wall portion, and a central gap between them configured to permit anterior-posterior adjustment of the tray relative to anterior teeth received in the socket, the central gap having a depth extending to a top surface of the floor and a width spanning a portion of at least four incisors such that the socket is open anteriorly at the central gap, whereby the tray is slidable in an anterior-posterior direction, between a maximum anterior installation position and a maximum posterior installation position, during installation of the splint; and a ramp projecting from a bottom of the floor and tapering from a thicker anterior end to a thinner posterior end.

2. The splint of claim 1, wherein the floor has a smooth top surface allowing anterior-posterior adjustment of the tray.

3. (canceled)

4. The splint of claim 1, wherein the central gap permits the tray to slide up to about 3 mm front-to-back, aligning an incisor with an imaginary arc between the left wall portion and right wall portion.

5. The splint of claim 1, wherein the ramp extends from an anterior end to a posterior end, the anterior end cantilevered from the tray's front.

6. (canceled)

7. The splint of claim 1, wherein the ramp tapers linearly from a first thickness at its anterior end to a second thickness at its posterior end, the first thickness being greater than the second thickness.

8. The splint of claim 7, wherein the first thickness is about 6 mm.

9. The splint of claim 1, wherein the ramp has sides chamfered at 45 to 65 degrees from horizontal to guide jaw movement if contacting a canine tooth.

10. The splint of claim 1, wherein the ramp has a width spanning a portion of at least three incisors.

11. The splint of claim 1, wherein the tray extends side-to-side to reach at least a premolar's posterior end on each side.

12. The splint of claim 11, wherein the tray reaches at least a molar's middle on each side.

13. The splint of claim 1, wherein the tray's back end forms a fulcrum at a premolar or molar, allowing the tray to tilt during installation to adjust vertical dimension occlusion with affixing material thickness between an incisor and the ramp.

14. The splint of claim 1, further comprising one or more retention features in the tray to resist escape of affixing material, the one or more retention features comprising at least one of an aperture, an indent, or a protrusion formed in the tray.

15. An adjustable anterior deprogrammer dental splint, comprising: a substantially U-shaped tray configured to fit into a mouth of a mammal, the tray having a tooth-receiving socket with a floor spacing apart an interior wall and an exterior wall, the exterior wall including a central gap sized to span a portion of at least three incisors and configured to permit anterior-posterior adjustment of the tray relative to anterior teeth received in the socket, the central gap having a depth extending to a top surface of the floor such that the socket is open anteriorly at the central gap, whereby the tray is slidable in an anterior-posterior direction during installation of the splint; and a ramp projecting from a bottom of the floor, tapering from a thicker anterior end to a thinner posterior end.

16. The splint of claim 15, wherein the central gap allows adjustment up to about 3 mm.

17. The splint of claim 15, wherein the ramp's anterior end is about 6 mm thick and spans a portion of at least three incisors.

18. An adjustable anterior deprogrammer dental splint, comprising: a substantially U-shaped tray configured to fit into a mouth of a mammal, the tray having a tooth-receiving socket with a floor spacing apart an interior wall and an exterior wall, and a posterior end configured to serve as a fulcrum aligned with a premolar or molar; wherein the exterior wall includes a left wall portion, a right wall portion, and a central gap between the left wall portion and the right wall portion, the central gap permitting anterior-posterior adjustment of the tray by up to about 3 mm; and a ramp projecting from a bottom of the floor, tapering from a thicker anterior end to a thinner posterior end, wherein tilting the tray around the fulcrum during installation adjusts vertical dimension occlusion between upper and lower jaws.

19. (canceled)

20. The splint of claim 18, wherein the ramp tapers linearly from a thickness of about 6 mm at the anterior end to a lesser thickness at the posterior end, and spans a portion of at least three incisors.

21. The splint of claim 18, wherein the fulcrum adjustment is facilitated by affixing material formed as a wedge between an incisor and a top surface of the ramp, providing an additional thickness during tilting.
